(19) United States
(12) Patent Application Publication
(10) Pub. No.: US 2023/0023283 A1
(43) Pub. Date: Jan. 26, 2023

(54) SYSTEMS AND METHODS FOR PIM DETECTION USING RAN MEASUREMENTS

(71) Applicant: Telefonaktiebolaget LM Ericsson (publ), Stockholm (SE)

(72) Inventors: Benny Lennartson, Hägersten (SE); Mats Blomgren, Stockholm (SE); Jin Ellgardt, Sundbyberg (SE); Erik Nilsson, Ottawa (CA)

(21) Appl. No.: 17/778,049

(22) PCT Filed: Dec. 23, 2020
(86) PCT No.: PCT/IB2020/062395

§ 371 Date: May 19, 2022

Related U.S. Application Data
(60) Provisional application No. 63/020,399, filed on May 5, 2020.

(51) Int. Cl. H04W 24/10; H04B 17/336

(52) U.S. Cl. CPC H04W 24/10; H04B 17/336

(57) ABSTRACT

Systems and methods for identifying Passive Intermodulation (PIM) products are disclosed. Some embodiments use RAN Performance Measurement (PM) counters, of actual DL Traffic Load to correlate with UL noise and interference counters. By using counters, the DL traffic is correlated to the increase in noise and interference in order to determine which DL carrier combinations are causing degradation to which UL carriers. In this way, aggressor-victim grouping can be identified through normal downlink traffic load with uplink interference to identify passive intermodulation products. This can be done for all aggressor-victim groups within a radio base station site or cluster of sites. Also, some embodiments enable estimating the maximum PIM interference created by the aggressor carriers. This helps operators to quantify the impact of PIM and can enable them to take counter measures. These embodiments are Radio Access Technology (RAT) agnostic and operator agnostic for the aggressors within a site.

### RELATED APPLICATIONS

This application claims the benefit of provisional patent application Ser. No. 63/020,399, filed May 5, 2020, the disclosure of which is hereby incorporated herein by reference in its entirety.

### TECHNICAL FIELD

The present disclosure relates to Passive Intermodulation (PIM) detection.

### BACKGROUND

Passive Intermodulation (PIM) is a constant problem in mobile networks. This can cause interference where two or more downlink carriers (aggressors) can mix and create interference that can fall in the uplink carrier (victim). The complexity increases as mobile network operators generally have several frequency bands that they use in their networks. To detect PIM is a time-consuming activity and the problem can arise on a site long after it has been built.

Currently there are several PIM detection solutions in a radio base station site. One is to manually inject artificial load on carriers that are known to be aggressors while monitoring the interference increase on the know victim. The second is PIM Detection in the radio unit. Improved systems and methods for PIM detection are needed.

### SUMMARY

Systems and methods for identifying Passive Intermodulation (PIM) products are disclosed. Some embodiments use Radio Access Network (RAN) Performance Measurement (PM) counters, of the network's actual Downlink (DL) Traffic Load to correlate with the Uplink (UL) noise and interference counters. By using counters, the proposed solution correlates the DL traffic to the increase in noise and interference in order to determine which DL carrier combinations are causing degradation to which UL carriers. In this way, aggressor-victim grouping can be identified through normal downlink traffic load with uplink interference in order to identify passive intermodulation products.

This can be done for all aggressor-victim groups within a radio base station site or cluster of sites. Also, some embodiments enable estimating the maximum PIM interference created by the aggressor carriers. This helps operators to quantify the impact of PIM and can enable them to take counter measures. These embodiments are Radio Access Technology (RAT) agnostic and operator agnostic for the aggressors within a site.

There are, proposed herein, various embodiments which address one or more of the issues disclosed herein. In some embodiments, a method performed by a processing device for detecting PIM includes one or more of: obtaining one or more Performance Measurements (PMs) related to downlink traffic of a communication network; obtaining one or more measurements related to uplink noise of the communication network; determining a relationship between the one or more PMs related to downlink traffic and the one or more measurements related to uplink noise; and detecting PIM based on the determined relationship.

In some embodiments, a method for detecting PIM using Performance Management data in a radio base station site include one or more of: collect data; extract and transform data; analysis; and report. In some embodiments, in addition to detecting that PIM exists in the victim cell, the embodiments also identify the possible aggressor/aggressors-cells.

Certain embodiments may provide one or more of the following technical advantage(s). The proposed solution might have several advantages including:
A) It is a non-invasive method and will thus not add to the traffic noise of the network since it is utilizing already existing DL measurement of traffic and power usage in a cell for PIM evaluation, e.g., utilizing existing traffic patterns for PIM Detection and Aggressor-Victim Identification.
B) The impact of PIM is analyzed with respect of the actual traffic scenario over time.
C) The PIM Detection and Aggressor-Victim Identification can be performed automatically, without any manual interaction, constantly throughout the lifespan of the cell phone site and not limited to certain maintenance or test windows as in previous solution. Thereby enabling monitoring of the PIM level over time.
D) The method is not radio specific and would work on any radio connected to the baseband.
E) Detects in-line PIM (PIM caused in the radio, coaxial jumpers, and the antenna) to the radio unit and external PIM where only the carriers on the Radio Base Station site are involved in the creation of the PIM.
F) The method is RAT agnostic as it correlates the downlink Traffic Load measure, which is proportional to the radiated power, with the measured uplink noise and interference level.
G) The method can predict the PIM level impact with respect to downlink traffic Load.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a wireless communication system represented as a 5G network architecture composed of core NFs, where interaction between any two NFs is represented by a point-to-point reference point/interface;

FIG. 3 illustrates a 5G network architecture using service-based interfaces between the NFs in the control plane, instead of the point-to-point reference points/interfaces used in the 5G network architecture of FIG. 2;

FIG. 4 illustrates a method performed by a processing device for detecting PIM, according to some embodiments of the present disclosure;

FIG. 5 illustrates a method for detecting PIM using Performance Management data in a radio base station site, according to some embodiments of the present disclosure;

FIG. 6 illustrates a Radio Base Station site that has three sectors, according to some embodiments of the present disclosure;

FIG. 7 illustrates that after the transformation and grouping there should be several aggressor-victim groups, according to some embodiments of the present disclosure;

FIG. 8 illustrates a linear regression created between the downlink traffic load measure and the uplink interference measure, according to some embodiments of the present disclosure;

FIG. 9 illustrates several uplink interference measures can be used per aggressor-victim group, according to some embodiments of the present disclosure;

FIG. 10 is a schematic block diagram of a radio access node according to some embodiments of the present disclosure;

FIG. 11 is a schematic block diagram that illustrates a virtualized embodiment of the radio access node according to some embodiments of the present disclosure;

FIG. 12 is a schematic block diagram of the radio access node according to some other embodiments of the present disclosure;

FIG. 13 is a schematic block diagram of a wireless communication device according to some embodiments of the present disclosure;

FIG. 14 is a schematic block diagram of the wireless communication device according to some other embodiments of the present disclosure;

FIGS. 15 and 16 illustrate a communication system includes a telecommunication network according to some other embodiments of the present disclosure; and

FIGS. 17-20 are flowcharts illustrating a method implemented in a communication system according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

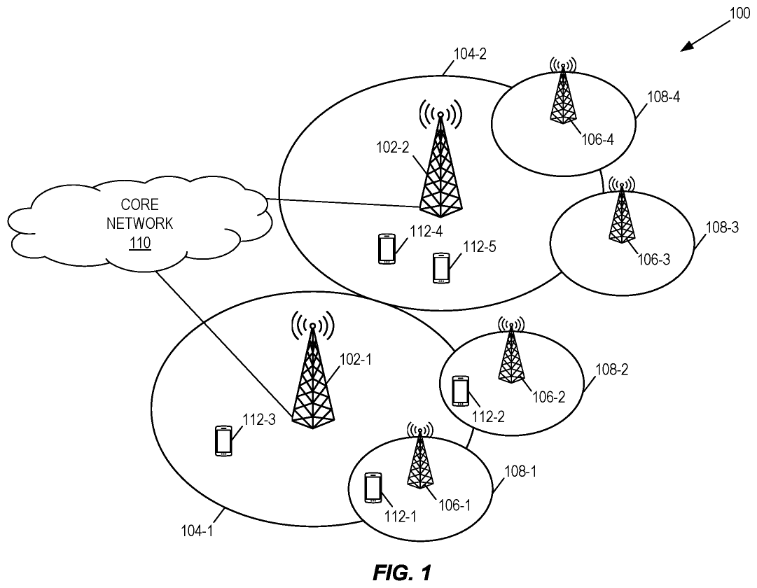

FIG. 1 illustrates one example of a cellular communications system 100 in which embodiments of the present disclosure may be implemented. In the embodiments described herein, the cellular communications system 100 is a 5G System (5GS) including a NR RAN or LTE RAN (i.e., Evolved Universal Terrestrial Radio Access (E-UTRA) RAN) or an Evolved Packet System (EPS) including a LTE RAN. In this example, the RAN includes base stations 102-1 and 102-2, which in LTE are referred to as eNBs (when connected to Evolved Packet Core (EPC)) and in 5G NR are referred to as gNBs (e.g., LTE RAN nodes connected to 5G Core (5GC), which are referred to as gn-eNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G Core (5GC). The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

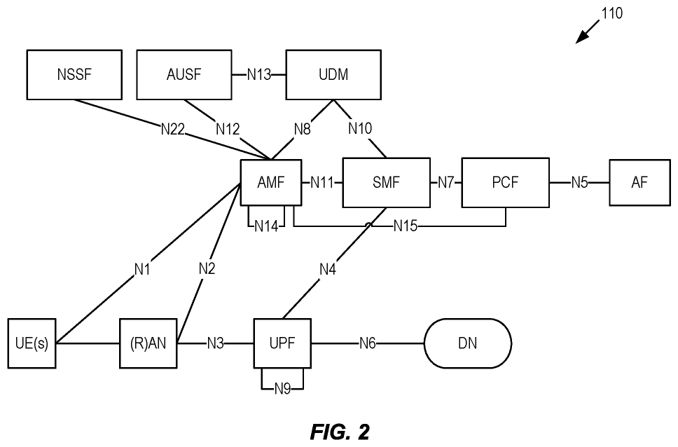

FIG. 2 illustrates a wireless communication system represented as a 5G network architecture composed of core NFs, where interaction between any two NFs is represented by a point-to-point reference point/interface. FIG. 2 can be viewed as one particular implementation of the system 100 of FIG. 1.

Seen from the access side, the 5G network architecture shown in FIG. 2 comprises a plurality of UEs connected to either a RAN or an Access Network (AN) as well as an AMF. Typically, the (R)AN comprises base stations, e.g., such as eNBs or gNBs or similar. Seen from the core network side, the 5G core NFs shown in FIG. 2 include a NSSF, an AUSF, a UDM, an AMF, a SMF, a PCF, and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMF, respectively. N12 is required for the AMF to perform authentication of the UE. N8 and N10 are defined because the subscription data of the UE is required for the AMF and SMF.

The 5GC network aims at separating user plane and control plane. The user plane carries user traffic while the control plane carries signaling in the network. In FIG. 2, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 2. Modularized function design enables the 5GC network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

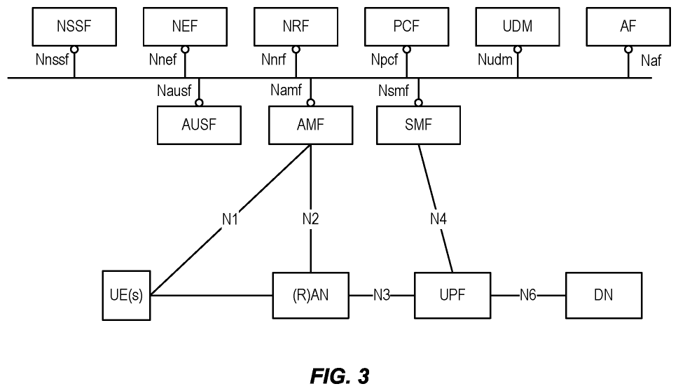

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g., Namf for the service based interface of the AMF and Nsmf for the service based interface of the SMF etc. The NEF and the NRF in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2 and 3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Passive Intermodulation (PIM) is a constant problem in mobile networks. This can cause interference where two or more downlink carriers (aggressors) can mix and create interference that can fall in the uplink carrier (victim). The complexity increases as mobile network operators generally have several frequency bands that they use in their networks. To detect PIM is a time-consuming activity, and the problem can arise on a site long after it has been built.

Currently there are several PIM Detection solutions in a radio base station site. One is to manually inject artificial load on carriers that are known to be aggressors while monitoring the interference increase on the know victim. The second is PIM Detection in the radio unit. Improved systems and methods for PIM detection are needed

Some PIM detection methods on RAN level use DL signals to excite the PIM source on the site and measure the excessive UL Interference and Noise level during the test window. The RBS generates artificial load to meet the target load level. If there is normal UE traffic at the same time, then this have priority and will be transmitted. This method sometimes refers to “PRB padding”, which fills up the number of Physical Resource Blocks (PRBs) in the system up to the required level. The draw-back with this methodology is that it has a network impact and generally needs to be done during times with low traffic or maintenance work windows.
A) DL test pilot detection methods are traffic invasive and contribute to increasing the network's traffic noise level, which in turn reduces the coverage and affects the end user performance. Therefore, the testing is not done frequently and is usually limited to maintenance windows. Consequently, it is limited to capturing the UL noise and Interference level due to PIM is varying over time.
B) DL pilot signals do not fully resemble the actual network DL statistic. Therefore, the detected PIM impact is only captured with respect to the configured DL load for that specific test pilot.
C) Current PIM detection tests on RAN level usually require a manual interaction with the node. The manual interaction is time-consuming and expensive and the cost increases with the number of sites to be screened.

Further there is a method in certain radio units that can detect PIM. However, there are limitations with this approach:
A) The aggressors and victims all need to be in this specific radio unit. No impact from other radios or to other radios will be measured or monitored.

Systems and methods for identifying PIM products are disclosed. Some embodiments use RAN Performance Measurement (PM) counters of the network's actual DL Traffic Load to correlate with the UL noise and interference counters. By using counters, the proposed solution correlates the DL traffic to the increase in noise and interference in order to determine which DL carrier combinations are causing degradation to which UL carriers. In this way, aggressor-victim grouping can be identified through normal downlink traffic load with uplink interference in order to identify passive intermodulation products.

This can be done for all aggressor-victim groups within a radio base station site or cluster of sites. Also, some embodiments enable estimating the maximum PIM interference created by the aggressor carriers. This helps operators to quantify the impact of PIM and can enable them to take counter measures. These embodiments are Radio Access Technology (RAT) agnostic and operator agnostic for the aggressors within a site.

A method performed by a processing device for detecting PIM is illustrated in FIG. 4. In some embodiments, the method includes one or more of: obtaining one or more PMs related to downlink traffic of a communication network (step 400); obtaining one or more measurements related to uplink noise of the communication network (step 402); determining a relationship between the one or more PMs related to downlink traffic and the one or more measurements related to uplink noise (step 404); and detecting PIM based on the determined relationship (step 406). In some embodiments, the measurements related to uplink noise include both noise and interference of any kind (other UEs-, External-, PIM, Interference, etc.)

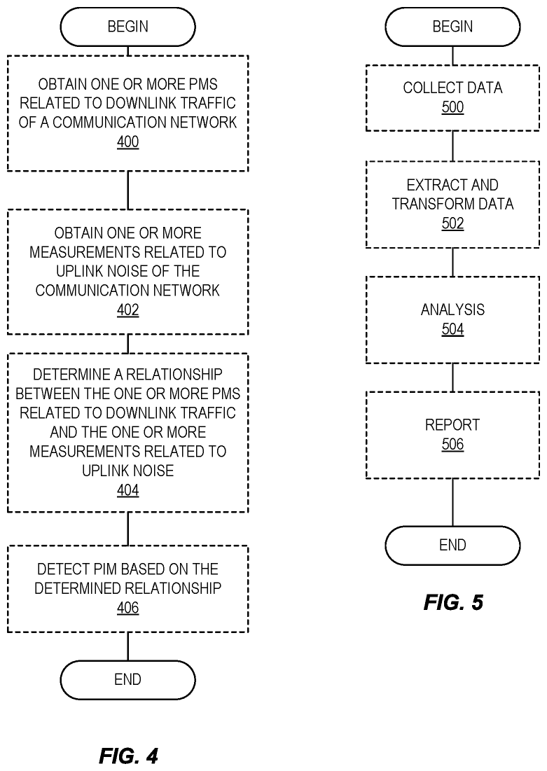

In some embodiments, a method for detecting PIM using Performance Management data in a radio base station site is seen in FIG. 5, according to some embodiments of the present disclosure. These four steps consist of one or more of: collect data (step 500); extract and transform data (step 502); analysis (step 504); and report (step 506). These are discussed below with additional example details. These methods can be performed by any appropriate node. In some embodiments, a radio base station or a network node can perform these steps. Additionally, in some embodiments, different nodes can perform some of the steps. In some embodiments, in addition to detecting that PIM exists in the victim cell, the embodiments also identify the possible aggressor/aggressors-cells.

As used herein, a site might refer to a group of base stations that are positioned close to each other. This positioning might be in such a manner that the transmitted output powers from the base stations can interact in a passive non-linear source/element and induce passive intermodulation interference that is sensed by the receiver of the base stations as PIM interference. In some embodiments, the antennas from the different base stations are just a few meters away (or less) from each other and the PIM can be created outside the antenna. In some embodiments, the base stations are located far away from each other, but the base stations' antennas are close enough to each other to allow for a PIM interference signal.

### Step 500. Collect Data

The first step is to collect the data. The data is performance measurements (PM) data from the RAN network. The PM data are observations when there is normal traffic in the network. That is, only normal user traffic is the basis for this method and no artificial load is generated.

There are two types of PM data collected:
a) Measurements with information of the downlink load on certain carrier frequency under a given time period.
b) Measurements with information of the uplink interference on a certain carrier frequency under a given time period.

The carrier frequency in this context can be a mobile carrier frequency span that occupies a certain frequency range. In some embodiments, this covers bandwidths that are a few kHz wide up to several hundred MHz wide. For example, a Wideband Code Division Multiple Access (WCDMA) DL carrier would occupy a 5 MHZ carrier Bandwidth (BW). Another embodiment is an LTE carrier where the carrier BW can be several individual Orthogonal Frequency Division Multiplexing (OFDM) carrier bandwidths and in other embodiments is the total BW of all OFDM carriers, for example 5 MHz.

It should be noted that the carrier can also be of any type of communication carrier where at least one of the transmitters has a variable energy transmitted. There are standard examples such as LTE, WCDMA, a Global System for Mobile Communications, or NR.

The downlink load in this context is when any energy is transmitted in this carrier. One example of a measure of the downlink load is the PRB Utilization for LTE. That is, what percent of the available PRBs on the LTE Downlink, were carrying data. This corresponds very well with how much energy is transmitted on the downlink.

The time period can be any time period from days to milliseconds. However, it should be mentioned that the method will work better in a shorter time period. And, in some embodiments, the time period is between 1 minute and 15 minutes.

In some embodiments, the PM data is collected from an LTE network, and the carrier BW frequencies are a mix of 15 and 20 MHz for where the data is collected.

In this embodiment, the measurements for a) are the PRB Utilization and the measurements of b) are the noise and interference power on a Physical Uplink Shared Channel (PUSCH) channel according to 3GPP standard 36.214. It should further be noticed that in the embodiment the b) measurements are done per PRB and Time Transmission Interval (TTI) (1 ms) but in this embodiment, both are aggregated per PRB on the uplink as well as in bins per interference level.

In this embodiment the time period is 15 minutes. This means that the measurements are collected and aggregated per 15 min.

### Step 502. Extract and Transform

The data collected needs to be transformed and grouped into possible downlink aggressor groups paired with possible uplink PIM interference Victims. These form an aggressor-victim group. In a radio base station site, with several downlink Carriers as well as uplink Carriers there can be very many such aggressor-victim groups.

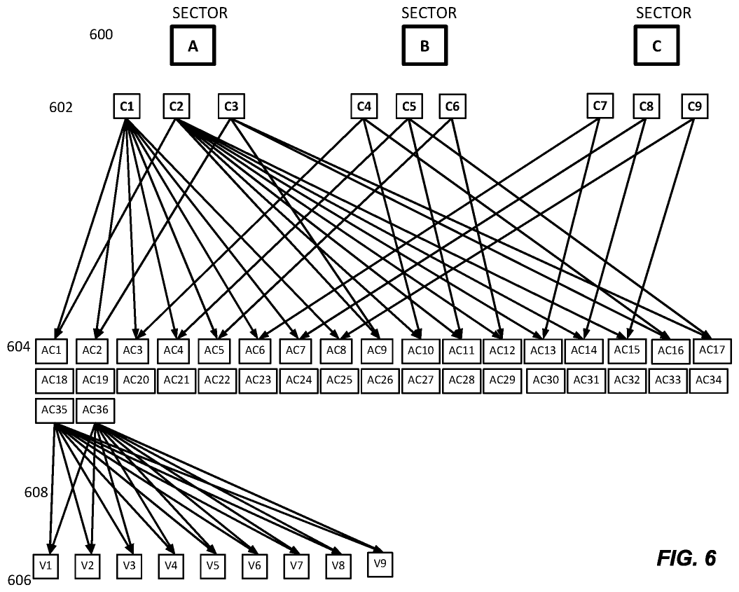

One embodiment can be seen in FIG. 6. This is a Radio Base Station site that has three sectors (600) named A, B and C. In each of these sectors there are three different downlink Carriers (602) named C1 to C9. These nine downlink BW Carriers can form several different downlink Aggressor groups. In this embodiment, seen in FIG. 6, there are 36 different downlink Aggressor groups (604) that have been illustrated. For example, the first downlink Aggressor group called AC1 consists of downlink Carrier C1 together with Carrier C2.

It should be noted that there could be other embodiments where there are 1, 3, 4, up to n different downlink Carriers in the same downlink Aggressor group. In one embodiment, there are a combination of 1 to n Aggressor Combinations in an aggressor group.

Each downlink Aggressor group is to be connected to an uplink Carrier that is the victim to the Passive Intermodulation. In the embodiment in FIG. 6, the uplink Carriers are illustrated as V1 to V9 (606). These uplink Carriers are suspect to PIM interference.

The downlink Aggressor groups together with uplink BW Carriers will form several aggressor-victim groups. In FIG. 6, one such aggressor-victim group is AC35 together with V1, illustrated by the line 608.

In the embodiment in FIG. 6, the uplink BW carrier is the combination of all receiver branches per carrier. However, there could be other embodiments where the uplink Carrier is divided into different Multiple Input Multiple Output (MIMO) Layers or Radio Frequency (RF) Ports if the installation supports such.

Once the data have been grouped into these aggressor-victim groups, a combined downlink Traffic Load Measure is calculated for the downlink Aggressor carriers. In the embodiment illustrated in FIG. 6, this measure is the product of the downlink PRB utilization of these two downlink Carriers during the time period, see Equation (EQ) 1:

DL Traffic Load Measure=average(DL PRB Utilization C1)×average(DL PRB Utilization C1) EQ1

The reason for using downlink PRB Utilization is that this is very close to describing the energy being transmitted on the downlink for this carrier. There could be other embodiments where the power on the downlink OFDM carriers is used; I/Q sample vectors are an example.

In other embodiments, the downlink Traffic Load Measure is created as the 90th percentile of the PRB utilization for each downlink Aggressor carrier. In yet another embodiment, if the joint distribution of downlink PRB Utilization between the aggressors is available, a joint percentile of the two carriers can be used as downlink Traffic Load Measure.

In yet another embodiment, the sum or the combination of sum and product of the downlink load on the carriers can be used to form the downlink Traffic Load Measure.

The downlink traffic load measure can be RAT agnostic. It can handle the combination of two different RAN Carriers on the downlink. In one embodiment, during the same time period, the downlink traffic load measure is the product of downlink WCDMA Power on aggressor carrier 1 with average LTE Downlink PRB Utilization on aggressor carrier 2.

For the uplink carriers, illustrated with V1 to V9 in FIG. 6, an uplink Interference Measure is calculated. In some embodiments, this uplink interference measure is the average PRB uplink noise and interference per time period, EQ2, where PRB_powerᵢ is the accumulated power measurements per PRB I during the time period.

$$uplink interference measure = \frac{1}{N} {\sum }_{i = 1}^{N} {PRB\_power}_{i} \qquad EQ2$$

In another embodiment, the uplink interference measure is a count of a number of TTIs that have a certain uplink interference level. One such example would be the number of TTIs during the time period that has between −109 and −110 dBm in uplink interference. In yet another embodiment, this can be the count of any specific bin of uplink interference.

In yet another embodiment, the uplink interference measure can be a percentile of different PRB_powerᵢ or the distribution of them.

In yet another embodiment, other UL measurements that are proportional to total UL received power can be used as the uplink interference measure in the PIM Detection and Aggressor-Victim Identification method.

### Step 504. Analysis

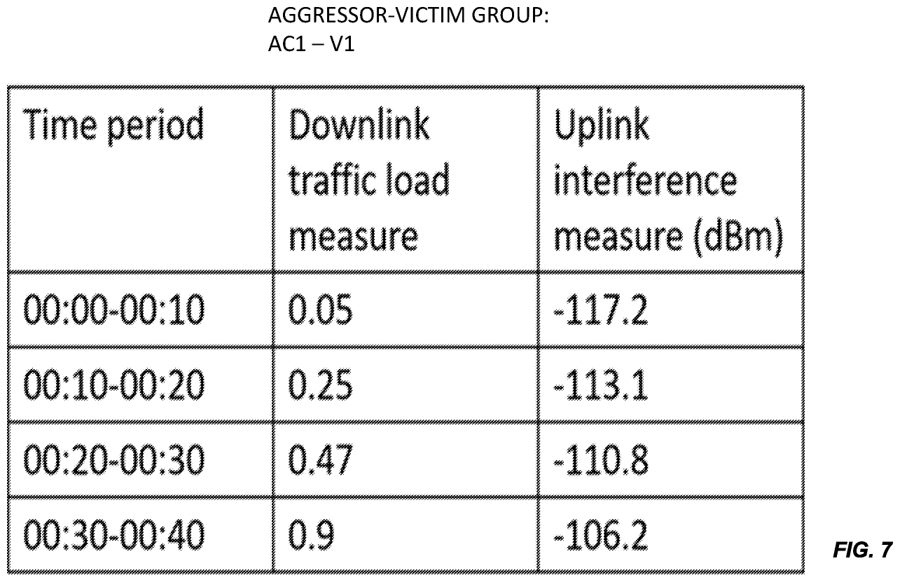

After the transformation and grouping, there should be several aggressor-victim groups, and for each such group samples of downlink traffic load measure and uplink interference measure. One such example can be seen in FIG. 7.

In some embodiments with nine Carriers on a site, this would result in 36×9=324 such aggressor-victim groups, assuming that the uplink interference measure is the average uplink interference in the victim carrier.

In some embodiments, the next step is to perform a correlation analysis per aggressor-victim group. If there is a strong correlation, then it is determined that Intermodulation artifacts are created by the aggressors and affect the victim in the group. Any type of correlation can be used including linear analysis or any machine learning techniques that can establish a relationship between the two. While this disclosure focuses on individual groups and the correlation between them, some embodiments could use other techniques such as principal component analysis to determine a combination of aggressors that would affect a victim. Other linear algebra methods could also be used. Some embodiments could use other machine learning techniques that look at the several aggressor combinations at the same time and the interaction between them in relation to the victim interference to determine if there is PIM and what specific aggressor combination that creates such. Examples of such techniques are Neural Networks or linear regression.

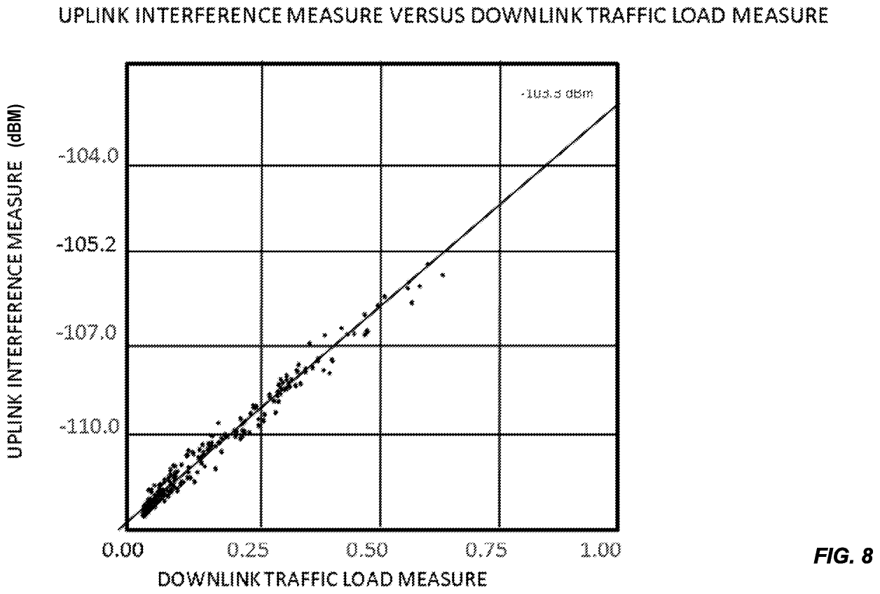

In FIG. 8, a linear regression is created between the downlink traffic load measure and the uplink interference measure. Each dot in this correlation represents the measurements collected in the time period of fifteen minutes. So, several 15-minute periods can be seen in this graph. In this particular plot, the downlink traffic load measure is the LTE downlink PRB utilization on carrier 1 multiplied with LTE downlink PRB utilization on carrier 2. This means that 1 on the x-axis corresponds to 100% of load used on both carriers during fifteen minutes. The uplink interference load measure is the average uplink interference. It is possible to see a clear correlation in this graph. So, it is very good indication that the two aggressor carriers are creating uplink PIM interference in the victim.

Further, in FIG. 8, it is possible to estimate the maximum PIM interference created by these two aggressor carriers. That would be where the regression line crosses the x value of 1. In the example in FIG. 8, this is −103 dBm.

In another embodiment, several uplink interference measures can be used per aggressor-victim group, see FIG. 9. In this embodiment, the count of TTIs where the uplink interference is within a specific range, i.e., between −110 and −111 dBm, is used. With 30 such ranges the number of aggressor-victim groups and a specific uplink interference measure will be 36×9×30=9720. If the correlation for one of these aggressor-victim groups is very good, then there is PIM created by the aggressors in this group and the maximum level of PIM that these aggressors can create is given by the specific range that this group have.

In some embodiments, various Machine Learning techniques can be used as part of the analysis. In some embodiments, a correlation coefficient is calculated between the downlink traffic load measure and the uplink interference measure. Examples of such load correlation measurements are Pearson, Kendall, or Spearman.

### Step 506. Report

In some embodiments, the outcome of the analysis is a list that for every aggressor-victim group has one or several Key Performance Indicators (KPIs) for this aggressor-victim group. In one embodiment, a correlation measure is calculated. In another embodiment the estimated maximum PIM interference that the aggressors can create is calculated.

In one embodiment, this list is used to trigger an alarm if the correlation and/or the estimated PIM is above a threshold. This can be used by operations and maintenance personnel when supervising the radio networks.

In another embodiment, this list is used as input to PIM Mitigation functions. That is functions that avoid transmitting aggressor carriers at the same time and thus reduce the PIM interference for the victim.

Yet another embodiment analysis of these different aggressor victim groups can result in a site map that displays what aggressor carriers in what directions on what radio hardware are creating PIM interference. Such a map can be used when troubleshooting if the interference is created in the Radio transmitter or in the feeders, splitters, jumpers, or antennas.

In yet another embodiment, where uplink interference measure is performed per receiver radio port, then the resulting list with aggressor-victim groups can help pinpoint if a certain port is affected by the uplink PIM interference or if more than one port is affected.

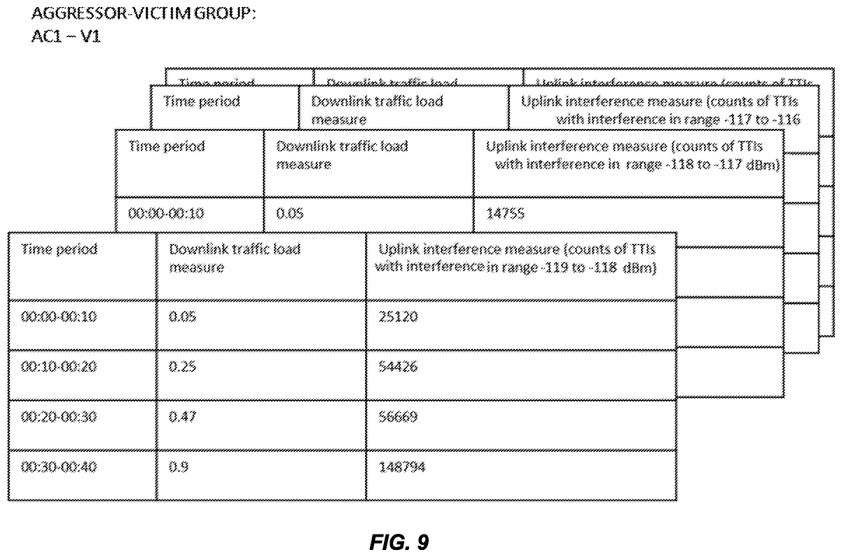

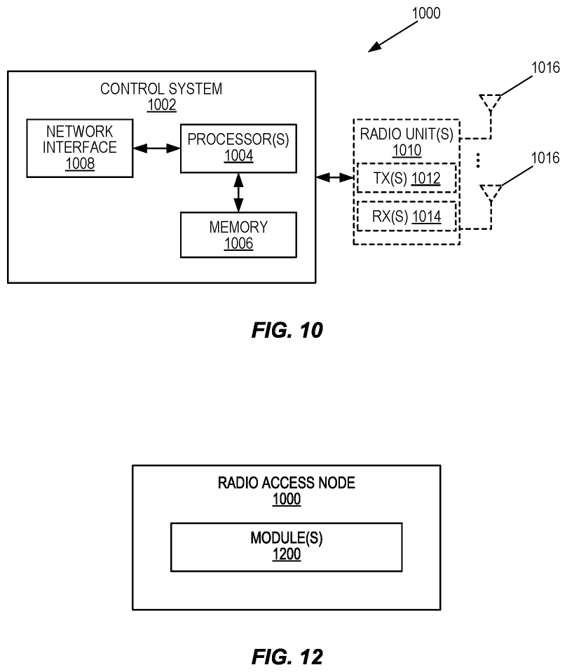

FIG. 10 is a schematic block diagram of a radio access node 1000 according to some embodiments of the present disclosure. Optional features are represented by dashed boxes. The radio access node 1000 may be, for example, a base station 102 or 106 or a network node that implements all or part of the functionality of the base station 102 or gNB described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

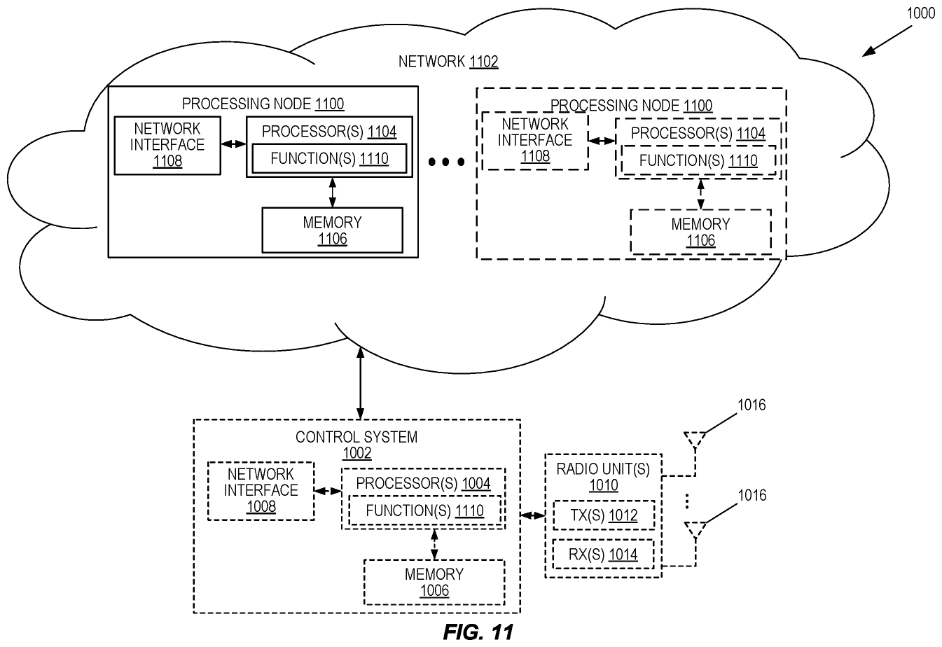

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

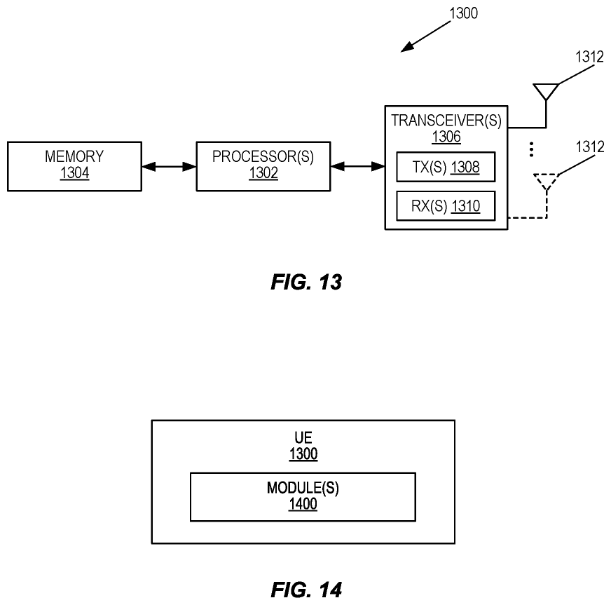

FIG. 13 is a schematic block diagram of a wireless communication device 1300 according to some embodiments of the present disclosure. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein.

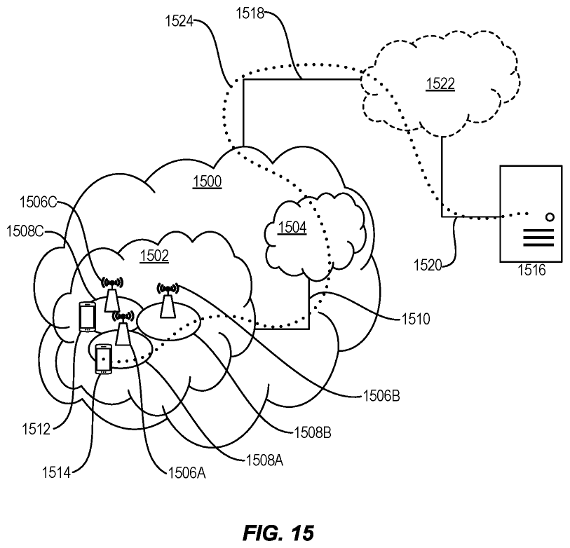

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

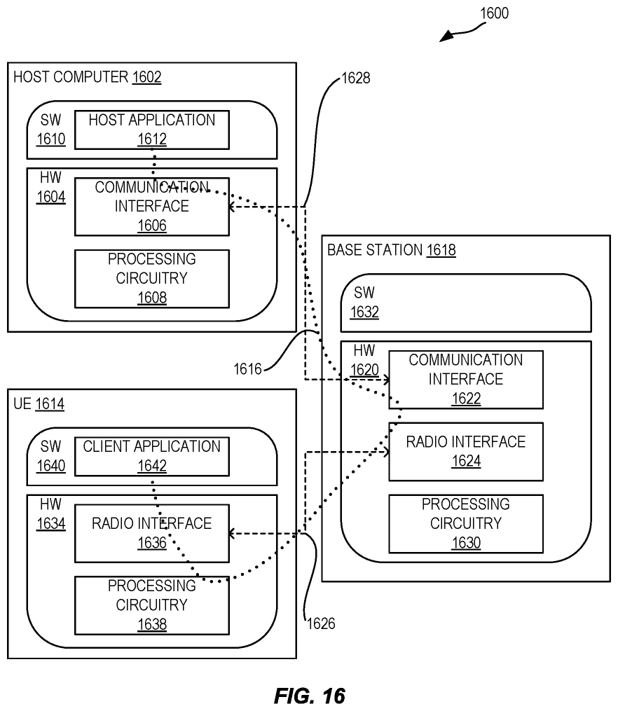

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer 1602's measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

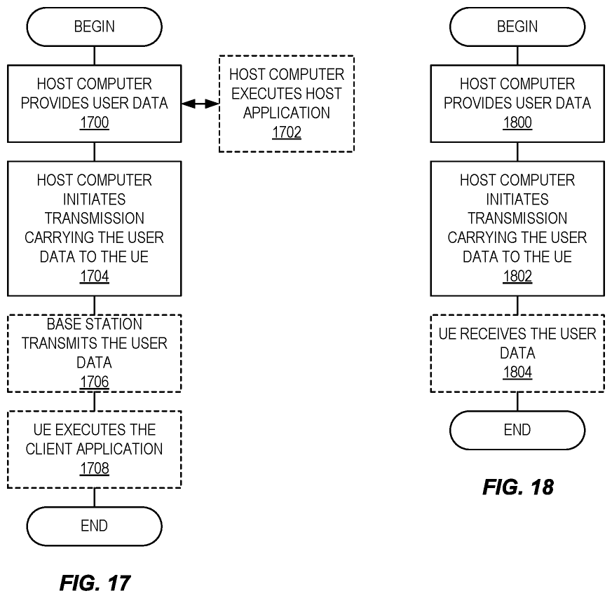

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

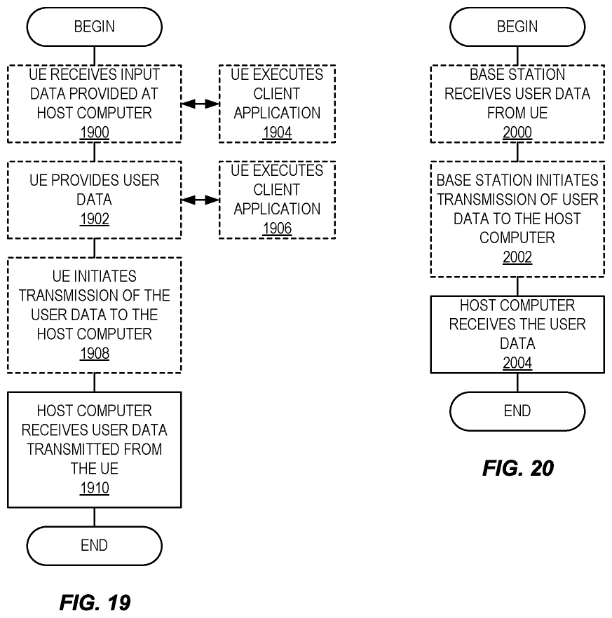

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a processing device for detecting Passive Intermodulation, PIM, the method comprising one or more of: obtaining (400) one or more Performance Measurements, PMs, related to downlink traffic of a communication network; obtaining (402) one or more measurements related to uplink noise of the communication network; determining (404) a relationship between the one or more PMs related to downlink traffic and the one or more measurements related to uplink noise; and detecting (406) PIM based on the determined relationship.

Embodiment 2: A method for detecting PIM using PM data in a radio base station site comprising one or more of: collect (500) data; extract and transform (502) data; analysis (504); and report (506).

Embodiment 3: The method of any of embodiments 1 to 2 wherein the one or more PMs related to downlink traffic comprise counters.

Embodiment 4: The method of any of embodiments 1 to 3 wherein the one or more measurements related to uplink noise comprise counters.

Embodiment 5: The method of any of embodiments 1 to 4, further comprising: determining which DL carrier combinations are causing degradation to which UL carriers.

Embodiment 6: The method of any of embodiments 1 to 5 wherein the one or more PMs related to downlink traffic are already calculated for other reasons.

Embodiment 7: The method of any of embodiments 1 to 6 wherein the PIM comprises one or more of the group consisting of: in-line PIM to the radio unit and external PIM.

Embodiment 8: The method of any of embodiments 1 to 7 wherein the one or more PMs related to downlink traffic are proportional to the radiated power.

Embodiment 9: The method of any of embodiments 1 to 8 wherein the one or more PMs related to downlink traffic are related to normal traffic in the communication network.

Embodiment 10: The method of any of embodiments 1 to 9 wherein the one or more PMs related to downlink traffic comprise measurements with information of the downlink load on certain carrier frequency under a given time period.

Embodiment 11: The method of any of embodiments 1 to 10 wherein detecting PIM based on the determined relationship comprises predicting a PIM level impact with respect to downlink traffic load.

Embodiment 12: The method of any of embodiments 1 to 11 wherein the one or more measurements related to uplink noise comprise measurements with information of the uplink interference on a certain carrier frequency under a given time period.

Embodiment 13: The method of any of embodiments 10 to 12 wherein the carrier frequency can be mobile carrier frequency span that occupy a certain frequency range.

Embodiment 14: The method of any of embodiments 1 to 13 wherein determining the relationship between the one or more PMs related to downlink traffic and the one or more measurements related to uplink noise comprises determining aggressor-victim groups and/or levels of interference between the aggressor-victim groups.

Embodiment 15: The method of any of embodiments 1 to 14 wherein determining the relationship between the one or more PMs related to downlink traffic and the one or more measurements related to uplink noise comprises determining a correlation between them.

Embodiment 16: The method of any of embodiments 1 to 15 wherein determining the relationship between the one or more PMs related to downlink traffic and the one or more measurements related to uplink noise comprises using several uplink interference measures per aggressor-victim group.

Embodiment 17: The method of any of embodiments 1 to 16 wherein the outcome of the analysis is a list that for every aggressor-victim group has one or more performance indicators for this aggressor-victim group.

Embodiment 18: The method of any of embodiments 1 to 17, further comprising: triggering an alarm if the PIM exceeds a threshold.

Embodiment 19: The method of any of embodiments 1 to 18, further comprising: triggering PIM mitigation functions if the PIM exceeds a threshold.

Embodiment 20: The method of any of embodiments 1 to 19, further comprising: determining a site map that displays what aggressor carriers, in what directions and/or on what radio hardware are creating PIM interference.

Embodiment 21: The method of any of the previous embodiments, further comprising: providing user data; and forwarding the user data to a host computer via the transmission to the base station.

### Group B Embodiments

Embodiment 22: A method performed by a base station for detecting Passive Intermodulation, PIM, the method comprising any of the steps of any of the Group A embodiments.

Embodiment 23: The method of any of the previous embodiments, further comprising: obtaining user data; and forwarding the user data to a host computer or a wireless device.

### Group C Embodiments

Embodiment 24: A base station for detecting Passive Intermodulation, PIM, the base station comprising: processing circuitry configured to perform any of the steps of any of the Group B embodiments; and power supply circuitry configured to supply power to the base station.

Embodiment 25: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 26: The communication system of the previous embodiment further including the base station.

Embodiment 27: The communication system of the previous 2 embodiments, further including the UE, wherein the UE is configured to communicate with the base station.

Embodiment 28: The communication system of the previous 3 embodiments, wherein: the processing circuitry of the host computer is configured to execute a host application, thereby providing the user data; and the UE comprises processing circuitry configured to execute a client application associated with the host application.

Embodiment 29: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 30: The method of the previous embodiment, further comprising, at the base station, transmitting the user data.

Embodiment 31: The method of the previous 2 embodiments, wherein the user data is provided at the host computer by executing a host application, the method further comprising, at the UE, executing a client application associated with the host application.

Embodiment 32: A User Equipment, UE, configured to communicate with a base station, the UE comprising a radio interface and processing circuitry configured to perform the method of the previous 3 embodiments.

Embodiment 33: A communication system including a host computer comprising: processing circuitry configured to provide user data; and a communication interface configured to forward user data to a cellular network for transmission to a User Equipment, UE; wherein the UE comprises a radio interface and processing circuitry.

Embodiment 34: The communication system of the previous embodiment, wherein the cellular network further includes a base station configured to communicate with the UE.

Embodiment 35: The communication system of the previous 2 embodiments, wherein: the processing circuitry of the host computer is configured to execute a host application, thereby providing the user data; and the UE's processing circuitry is configured to execute a client application associated with the host application.

Embodiment 36: A method implemented in a communication system including a host computer, a base station, and a User Equipment, UE, the method comprising: at the host computer, providing user data; and at the host computer, initiating a transmission carrying the user data to the UE via a cellular network comprising the base station.

Embodiment 37: The method of the previous embodiment, further comprising at the UE, receiving the user data from the base station.

Embodiment 38: A communication system including a host computer comprising: communication interface configured to receive user data originating from a transmission from a User Equipment, UE, to a base station; wherein the UE comprises a radio interface and processing circuitry.

Embodiment 39: The communication system of the previous embodiment, further including the UE.

Embodiment 40: The communication system of the previous 2 embodiments, further including the base station, wherein the base station comprises a radio interface configured to communicate with the UE and a communication interface configured to forward to the host computer the user data carried by a transmission from the UE to the base station.

Embodiment 41: The communication system of the previous 3 embodiments, wherein: the processing circuitry of the host computer is configured to execute a host application; and the UE's processing circuitry is configured to execute a client application associated with the host application, thereby providing the user data.

Embodiment 42: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 43: A method implemented in a communication system including a host computer, a base station, and a User Equipment, UE, the method comprising: at the host computer, receiving user data transmitted to the base station from the UE.

Embodiment 44: The method of the previous embodiment, further comprising, at the UE, providing the user data to the base station.

Embodiment 45: The method of the previous 2 embodiments, further comprising: at the UE, executing a client application, thereby providing the user data to be transmitted; and at the host computer, executing a host application associated with the client application.

Embodiment 46: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 47: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 48: The communication system of the previous embodiment further including the base station.

Embodiment 49: The communication system of the previous 2 embodiments, further including the UE, wherein the UE is configured to communicate with the base station.

Embodiment 50: The communication system of the previous 3 embodiments, wherein: the processing circuitry of the host computer is configured to execute a host application; and the UE is configured to execute a client application associated with the host application, thereby providing the user data to be received by the host computer.

Embodiment 51: A method implemented in a communication system including a host computer, a base station, and a User Equipment, UE, the method comprising: at the host computer, receiving, from the base station, user data originating from a transmission which the base station has received from the UE.

Embodiment 52: The method of the previous embodiment, further comprising at the base station, receiving the user data from the UE.

Embodiment 53: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
BW Bandwidth
CPU Central Processing Unit
DL Downlink
DN Data Network
DSP Digital Signal Processor
eNB Enhanced or Evolved Node B
EPC Evolved Packet Core
EPS Evolved Packet System
EQ Equation
E-UTRA Evolved Universal Terrestrial Radio Access
FPGA Field Programmable Gate Array
gNB New Radio Base Station
gNB-CU New Radio Base Station Central Unit
gNB-DU New Radio Base Station Distributed Unit
HSS Home Subscriber Server
IoT Internet of Things
IP Internet Protocol
KPI Key Performance Indicator
LTE Long Term Evolution
MIMO Multiple Input Multiple Output
MME Mobility Management Entity
MTC Machine Type Communication
NEF Network Exposure Function
NF Network Function
NR New Radio
NRF Network Function Repository Function
NSSF Network Slice Selection Function
OFDM Orthogonal Frequency Division Multiplexing
OTT Over-the-Top
PC Personal Computer
PCF Policy Control Function
P-GW Packet Data Network Gateway
PIM Passive Intermodulation
PM Performance Measurement
PRB Physical Resource Block
PUSCH Physical Uplink Shared Channel
QoS Quality of Service
RAM Random Access Memory
RAN Radio Access Network
RAT Radio Access Technology
RF Radio Frequency
ROM Read Only Memory
RRH Remote Radio Head
RTT Round Trip Time
SCEF Service Capability Exposure Function
SMF Session Management Function
TTI Time Transmission Interval
UDM Unified Data Management
UE User Equipment
UL Uplink
UPF User Plane Function
WCDMA Wideband Code Division Multiple Access

Those skilled in the art will recognize improvements and modifications to the embodiments of the present disclosure. All such improvements and modifications are considered within the scope of the concepts disclosed herein.

1. A method performed by a processing device for detecting Passive Intermodulation, PIM, the method comprising:
obtaining one or more Performance Measurements, PMs, related to downlink traffic of a communication network;
obtaining one or more measurements related to uplink noise of the communication network;
determining a relationship between the one or more PMs related to downlink traffic and the one or more measurements related to uplink noise; and
detecting the PIM based on the determined relationship.

2. The method of claim 1 wherein the one or more PMs related to downlink traffic comprise counters.

3. The method of claim 1 wherein the one or more measurements related to uplink noise comprise counters.

4. The method of claim 1 wherein the one or more PMs related to downlink traffic comprise a Physical Resource Block, PRB, utilization.

5. The method of claim 1, further comprising:
determining which Downlink, DL, carrier combinations are causing degradation to which Uplink, UL, carriers.

6. The method of claim 1 wherein the one or more PMs related to downlink traffic are already calculated for other reasons.

7. The method of claim 1 wherein the PIM comprises one or more of the group consisting of: in-line PIM to a radio unit and external PIM.

8. The method of claim 1 wherein the one or more PMs related to downlink traffic are proportional to radiated power.

9. The method of claim 1 wherein the one or more PMs related to downlink traffic are related to normal traffic in the communication network.

10. The method of claim 1 wherein the one or more PMs related to downlink traffic comprise measurements with information of a downlink load on a certain carrier frequency under a given time period.

11. The method of claim 1 wherein detecting the PIM based on the determined relationship comprises predicting a PIM level impact with respect to a downlink traffic load.

12. The method of claim 1 wherein the one or more measurements related to uplink noise comprise measurements with information of uplink interference on the certain carrier frequency under a given time period.

13. The method of claim 10 wherein the carrier frequency can be a mobile carrier frequency span that occupies a certain frequency range.

14. The method of claim 1 wherein determining the relationship between the one or more PMs related to downlink traffic and the one or more measurements related to uplink noise comprises determining aggressor-victim groups and/or levels of interference between the aggressor-victim groups.

15. The method of claim 1 wherein determining the relationship between the one or more PMs related to downlink traffic and the one or more measurements related to uplink noise comprises determining a correlation between them.

16. The method of claim 1 wherein determining the relationship between the one or more PMs related to downlink traffic and the one or more measurements related to uplink noise comprises using several uplink interference measures per aggressor-victim group.

17. The method of claim 1 wherein the outcome of the analysis is a list that for every aggressor-victim group has one or more performance indicators for this aggressor-victim group.

18. The method of claim 1, further comprising:
triggering an alarm if the PIM exceeds a threshold.

19. The method of claim 1, further comprising:
triggering PIM mitigation functions if the PIM exceeds a threshold.

20. The method of claim 1, further comprising:
determining a site map that displays what aggressor carriers, in what directions and/or on what radio hardware are creating PIM interference.

21. A processing device for detecting Passive Intermodulation, PIM, the processing device comprising:
one or more processors; and
memory comprising instructions to cause the processing device to:
obtain one or more Performance Measurements, PMs, related to downlink traffic of a communication network;
obtain one or more measurements related to uplink noise of the communication network;
determine a relationship between the one or more PMs related to downlink traffic and the one or more measurements related to uplink noise; and
detect the PIM based on the determined relationship.

22. (canceled)
